(19) United States
(12) Patent Application Publication
(10) Pub. No.: US 2005/0223318 A1
(43) Pub. Date: Oct. 6, 2005

(54) System for implementing an electronic presentation from a storyboard

(75) Inventors: Michael E. Diesel, Saugus, MA (US); Peter J. Isermann, Rossville, KS (US); Richard T. Beck IV, Rossville, KS (US); Jeffrey L. Knight, St. Marys, KS (US); Shane W. Hill, St. Marys, KS (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Automatic e-Learning, LLC, St. Marys, KS (US)

(21) Appl. No.: 11/102,577

(22) Filed: Apr. 7, 2005

Related U.S. Application Data
(63) Continuation-in-part of application No. 11/028,466, filed on Jan. 3, 2005.
(63) Continuation-in-part of application No. 11/016,552, filed on Dec. 17, 2004.
(63) Continuation-in-part of application No. 10/287,441, filed on Nov. 1, 2002.
(63) Continuation-in-part of application No. 10/287,464, filed on Nov. 1, 2002.
(63) Continuation-in-part of application No. 10/287,468, filed on Nov. 1, 2002.
(60) Provisional application No. 60/533,698, filed on Dec. 31, 2003.
(60) Provisional application No. 60/530,457, filed on Dec. 17, 2003.
(60) Provisional application No. 60/334,714, filed on Nov. 1, 2001.
(60) Provisional application No. 60/400,606, filed on Aug. 1, 2002.
(60) Provisional application No. 60/334,714, filed on Nov. 1, 2001.
(60) Provisional application No. 60/400,606, filed on Aug. 1, 2002.
(60) Provisional application No. 60/334,714, filed on Nov. 1, 2001.
(60) Provisional application No. 60/400,606, filed on Aug. 1, 2002.

(51) Int. Cl. G06F 17/00

(52) U.S. Cl. 715/513; 715/730; 715/525

(57) ABSTRACT

A highly portable user-friendly development environment is provided that can enable the creative design of custom electronic presentations. Users can design their own custom presentations from a storyboard document, and collaborate with others during the development process. The document-based authoring environment uses a standard word processing document and the structure and content of the presentation can be defined using constructs. The development of presentations can take place in the cells of an electronic table of the word processing document. The constructs are specified in connection with the table, and a build process can process the document and generate a presentation based on the constructs and the content in the table. This document-based authoring environment can expand the possibilities of e-learning course development beyond conventional database development environments.

### RELATED APPLICATIONS

This application is a Continuation-in-Part of U.S. patent application Ser. No. 11/028,466 filed Jan. 3, 2005, which claims the benefit of U.S. Patent Application No. 60/533,698 filed Dec. 31, 2003; and this application is also a Continuation-in-Part of U.S. patent application Ser. No. 11/016,552 filed Dec. 17, 2004, which claims the benefit of U.S. Provisional Application No. 60/530,457, filed on Dec. 17, 2003, of which U.S. patent application Ser. No. 11/016,552 is also a Continuation-in-Part of U.S. patent application Ser. Nos. 10/287,441, filed Nov. 1, 2002, Ser. No. 10/287,464, filed Nov. 1, 2002 and 10/287,468, filed Nov. 1, 2002, all of which claim priority to Provisional Patent Application Nos. 60/334,714, filed Nov. 1, 2001 and 60/400,606, filed Aug. 1, 2002; the entire teachings of all the above-mentioned applications are incorporated herein by reference.

### BACKGROUND

There are a number of ways to create an electronic presentation. The electronic presentation may be any multimedia presentation, electronic learning (e-learning) course, interactive courseware, video or film. Often, a storyboard is created to outline the scene sequence and plot in the electronic presentation. The storyboard may include a representation of media elements of a finished presentation. Traditionally, a storyboard is used to capture ideas in paper or electronic form.

An electronic storyboard may utilize a tablet or speech recognition program to input ideas into the electronic storyboard. Once the basic concepts and visualization are captured in a storyboard, the electronic presentation is produced. The storyboard typically includes a combination of text, audio, video and animated content, which need to be arranged into an electronic presentation using multimedia authoring tools.

In the typical scenario, there is a combination of parties involved in the development of the electronic presentation as it moves from storyboard to multimedia authoring tools, to presentation deployment. For example, a subject matter expert may determine the content, an instructional designer may make suggestions as to how the content may best be formatted for the target audience, and a technical designer and possibly software developer may build the presentation. Technical parties are generally involved because often the subject matter expert does not have the requisite technical skills required to effectively create a media rich multimedia presentation using the multimedia authoring tools.

Conventional electronic presentation and courseware development tools use media management systems, such as database systems. This backend database component has been extremely important in enabling the organization of the content for presentation or e-learning course. However, developing interactive presentations and courseware in connection with databases requires a high level of expertise. For example, if the database is a relational database, experts define certain levels of relationships, such as one-to-many relationships, many-to-many or many-to-one relationships. In general, most multimedia development environments are not very user-friendly and they require an experienced developer, which effectively blocks the subject matter expert from accessing the course development materials. Further, access to the authoring tools and backend database is usually required in order to make changes to the presentation, thus hindering collaboration between the parties.

Thus, one of the biggest challenges in developing multimedia products that are tailored to a particular industry or company's needs is that, in general, highly-trained technical designers develop the multimedia product, which can be cost-prohibitive. Moreover, innovative multimedia presentations often involve rapid exploration of numerous design alternatives, and as a result, the technical designers may create numerous versions of the product during the development cycles and typically, these changes are made using a multimedia authoring tool. Because such technical designers are often poorly versed in the needs and demands of a particular industry or company's needs, the final product often does not effectively satisfy the needs or demands of the company unless the subject matter expert is substantially involved during each iteration of the product. Such frequent revisions, however, can be costly.

Ideally, the company's personnel or subject matter experts could create their own multimedia product so that the company could effectively tailor its course to meet its needs. In general, however, the average company employee and subject matter expert does not possess the software development skills and software tools to create or update such a system. Therefore, it is typically not possible for a company to have its normal employees or have a subject matter expert design its multimedia systems.

Content users want user-friendly interactive presentations with rich media. Meanwhile, companies want a development environment that is easily implemented and enables them to easily, effectively and efficiently deploy rich media content. In addition, companies want a development environment that enables them to develop an innovative interactive presentation and rapidly explore numerous design alternatives during the development cycles. Thus, one of the most complicated aspects of developing a content development and deployment system is finding a scheme in which the cost benefit analysis accommodates all participants. At this time, the currently available schemes do not provide a user-friendly, developer-friendly, and financially effective solution to develop multimedia content.

### SUMMARY

The present system includes a highly-portable user-friendly development environment that can enable the creative design of custom software products, such as browser-based presentations and courses. The present system can expand the possibilities of e-learning course development beyond conventional database development environments. In particular, the development of an interactive presentation from a storyboard can take place in the cells of an electronic table of a word processing document.

A particular embodiment is a computerized method of implementing an electronic presentation from a storyboard. A standard electronic document can be processed to determine presentation data and constructs specified in the document. One of the specified constructs is a storyboard construct. In response to identifying a storyboard construct, at least a portion of the presentation data can be determined to correspond to storyboard data. The storyboard data can then be used to create an electronic presentation.

The presentation data in the document can be processed into pages based on the specified constructs. More particularly, the presentation data can be parsed into HTML pages based on the specified constructs. The HTML pages can be stored in a temporary storage location. XML data for each HTML page can be generated from the HTML pages. An XML mapping structure that defines the sequence of the HTML pages in the presentation can be generated. The XML mapping structure can correspond to a course structure that defines chapters in the presentation, where each chapter can have respective pages. The XML mapping structure can control textual content, synchronization information, pointers to media files, and hotspots and drop-zones associated with each page in the presentation.

In determining that a portion of the presentation data corresponds to storyboard data, an electronic table adjacent to the storyboard construct in the document can be identified. The storyboard construct can, for example, be above the table in the document, when the table could correspond to a storyboard table. The storyboard data can be specified in the cells of the storyboard table. Furthermore, storyboard data can define the electronic content associated with the presentation including any textual content, synchronization information, pointers to media files, interactive exercises, buttons, and images with hotspots and drop-zones. The electronic content associated with each page in the presentation can be controlled using the storyboard table. The storyboard table can enable media files to play across sequential pages in the presentation.

When processing the document to determine presentation data and specified constructs in the document, the constructs can be compared with known builder constructs. The builder constructs can include any storyboard construct, media construct, exercise construct, pretest construct, and quiz construct.

In another particular embodiment, a system can implement a storyboard from a document. A document handler can be responsive to one or more builder constructs specified in a document. A builder can be in communication with the document handler. The builder can determine the structure for an electronic presentation based at least in part on a storyboard construct specified in the document. The builder can determine a structure for the presentation by identifying presentation data and associated builder constructs specified in the document to generate computer readable instructions associated with the presentation. A player, such as an XML player, can be used to process the computer readable instructions and generate the presentation.

Because an authoring environment can be primarily document-based, an extremely flexible storyboard-based authoring environment can be created that is highly desirable for instructional designers that work with subject matter experts in disparate locations. For example, data exchange is enabled via email, FTP, File Servers and Microsoft Word® applications. Changes made to content in the storyboard can be easily reviewed by using standard tools, such as the track changes feature of Microsoft Word. Unlike other industry storyboarding processes, however, an authoring environment can build a course directly from data stored in the document itself, without a course designer having to be on the network and access a complex authoring system with a database containing the structure of the course. In this way, course development can be a collaborative process among parties in disparate locations.

### BRIEF DESCRIPTION OF THE DRAWINGS

The foregoing and other objects, features and advantages of the invention will be apparent from the following more particular description of the System for Implementing an Electronic Presentation From a Storyboard, as illustrated in the accompanying drawings in which like reference characters refer to the same parts throughout the different views. For clarity and ease of description, the drawings are not necessarily to scale, emphasis instead being placed upon illustrating the principles of the invention.

FIG. 1 is a block diagram illustrating a system for deploying an interactive presentation according to an embodiment.

FIG. 2 is a diagram illustrating an interactive presentation displayed in a browser user interface.

FIG. 3 is a block diagram illustrating database system architecture for creating an interactive presentation.

FIG. 4 is a flow diagram showing an example of the process of developing an interactive presentation according to an aspect of FIG. 3.

FIG. 5 is a block diagram illustrating the system architecture for creating an interactive presentation in a document-based authoring environment according to an embodiment of the present invention.

FIG. 6 is a flow diagram describing a document-based authoring process according to an aspect of FIG. 5.

FIG. 7 is a block diagram illustrating an embodiment of the document-based authoring environment according to an embodiment of FIG. 5.

FIG. 8 is a diagram illustrating an interface used in connection with creating an interactive presentation from a document-based authoring environment with a table wizard according to an embodiment of the invention.

FIG. 9 is a table providing examples of constructs.

FIG. 10 is a block diagram of the table wizard using a timer process to control and manage the state of a word processing document.

FIG. 11 is a diagram illustrating the selection of a row in a storyboard table according to an embodiment of FIG. 9.

FIG. 12 is a diagram illustrating a page specified in the media table of FIG. 8.

FIG. 13 is a diagram illustrating the storyboard specified in the storyboard table of FIG. 8.

FIGS. 14A-14B are flow diagrams of an example of a software system that handles a build process.

FIG. 15 is a diagram illustrating an example of a software system that implements a player.

### DETAILED DESCRIPTION

A number of different participants may be involved in developing, deploying and using an interactive presentation. For purposes of illustration, an interactive presentation designed as an e-learning course may require a developer (e.g. a subject matter expert, graphic artist and instructional designer) who is involved in the development and deployment of the e-learning course. A user (e.g. learner, student or viewer) who accesses, uses and interacts with the interactive presentation, and a network administrator who may install content and updates (e.g. new releases, new presentations or new courses).

System Architecture

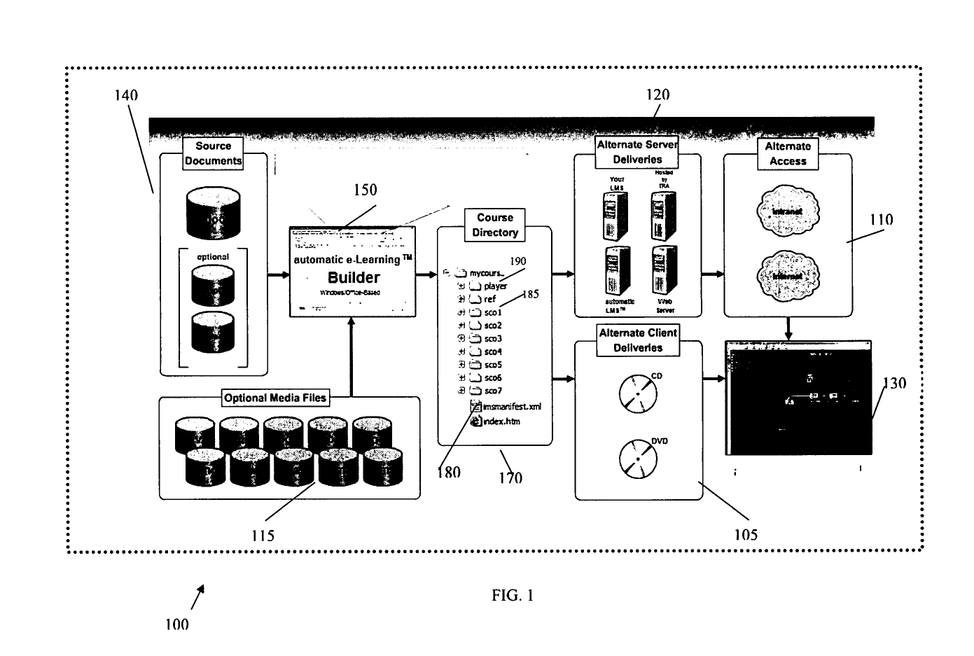

An interactive presentation may be deployed over a network or from an offline device. For instance, FIG. 1 is a block diagram illustrating a system for deploying an interactive presentation according to an embodiment. An interactive presentation 130 can be developed and deployed from an offline storage medium, such as a CD or DVD 105. The interactive presentation 130 can alternatively be deployed from a server 120 via a network 110. The network 110 can be any type of network topology, such as Internet or Intranet. A player 190 can be stored and associated with the interactive presentation 130. The player 190 can generate the interactive presentation 130 and facilitate management of both hardware and software components at a client system.

The client system preferably includes a web browser for accessing and displaying the interactive presentation 130. The presentation 130 can optionally include media files 115. It is desired that the web browser support media that is in an Internet animation or video format, and such as Flash™, Shockwave™, Windows Media™, Real Video™, QuickTime™, a mark-up language, such as any dialect of Standard Generalized Markup Language (SGML), and a scripting language, such as JavaScript, Jscript, ActionScript, etc. Internet animation and video formats include audiovisual data that can be presented via a web browser. Scripting languages include instructions interpreted by a web browser to perform certain functions, such as how to display data.

Content creation software for developing the interactive presentation 130 may include a builder 150 and a source document 140, such as a Word document or e-mail. The builder 150 may access optional interactive presentation data objects such as text, sound, video, still and animated graphics, applets, interactive content, and templates to create a course package 170, which is used to generate the interactive presentation 130.

The e-learning course structure defines the structure and content of the interactive presentation 130. The course package 170 for the interactive presentation 130 is preferably structured by folders (e.g. chapters) 160. In this particular embodiment, an imsmanifest.xml file is used to package the course for the Learning Management Sever (LMS) 120. The imsmanifest.xml file 180 is used in accordance with Sharable Content Object Reference Model (SCORM) recommendations, and it defines the course structure of the interactive presentation 130 for the LMS 120 including each chapter 160 and title used in the course. Each chapter directory 160 includes a respective course structure file (csf.xml) that further defines the structure of the chapter 160. The chapters 160 feature sharable content objects consisting of one or more or lessons in the interactive presentation. Each chapter 160 includes several pages. The pages provide instructional data, navigational tools and interactive exercises and assessments, which are used in the interactive presentation 130.

The builder 150 creates a build directory, which is used to create the course package 170 for the interactive presentation 130. The player 190 is included in the course package 170. The player 190 may include a hyper-download system. Preferably, the hyper-download system is as described in U.S. patent application Ser. No. 10/287,468, filed on Nov. 1, 2002, which is incorporated herein by reference in its entirety. The hyper-download system may include a pre-loading engine that systematically delivers specific layers of content from the course directory to generate the interactive presentation 130.

The player 190 is used to generate and deploy the interactive presentation 130 using the course structure file and other supporting files in the course package 170. The player 190 can parse XML data in the course package 170 and render it into a format that the browser requires. Preferably, the course structure file is an XML structure that defines the structure of interactive presentation 130. The structure can include chapters 160. Pages can be included within the chapters 160. In the example shown in FIG. 1, the chapters 160 are folders in the course directory of the course package 170. Each folder is given a folder title in the course structure file. Each page is referenced in the course structure file using an alias, such as <folder><page ref=‘c2-1’></folder>. In this way, the XML course structure can point to a chapter 160 and its pages. For example, a page in a chapter can be linked in the content section of the XML course structure file as follows:

```
<content>
    <c2-13>
    <title>Summary</title>
    <type>scriptedflash</type>
    <data ref=“c2-13.XML”/>
    <mediafiles>55916-0001.swf</mediafiles>
    </c2-13>
</content>
```

The page alias, <c2-13>, the title of the page, <title>Summary</title>, the type of page, <type>scriptedflash</type>, a data reference link, <data ref=“c2-13.XML”/>, and specific media files <mediafiles>55916-0001.swf</mediafiles>are referenced in the content section of the XML course structure file. In this example, some page assets are referenced, such as the data reference link, which references an XML file, and the media file, which references a Flash, “swf file.”

The information in the course structure file can be stored in XML and in JavaScript arrays. By storing the course structure in a course structure file (e.g. XML files) or in memory locations (e.g. JavaScript arrays), the design of the course can be simplified at one location, and the viewing experience for a user can be enhanced. In particular, this centralized approach enables all components of the interactive presentation 130 to be fully integrated with the course structure. Software components can access the course structure and receive the most up to date information about the interactive presentation 130. In this way, a centralized approach can be used in integrating and developing a multi-megabyte presentation.

Interactive Presentation

The interactive presentation 130 can be operated by a user, such as a student in an e-learning course. The e-learning course can relate to any subject matter, such as education, entertainment, or business. An interactive presentation 130 can be the learning environment or classroom component of the e-learning course. The interactive presentation 130 can be a website or a multimedia presentation. Embodiments, such as the interactive presentation 130, or more specifically, the e-learning course product, are commercially available from Telecommunications Research Associates, LLC of St. Marys, Kans. and Automatic e-Learning, LLC of St. Marys, Kans.

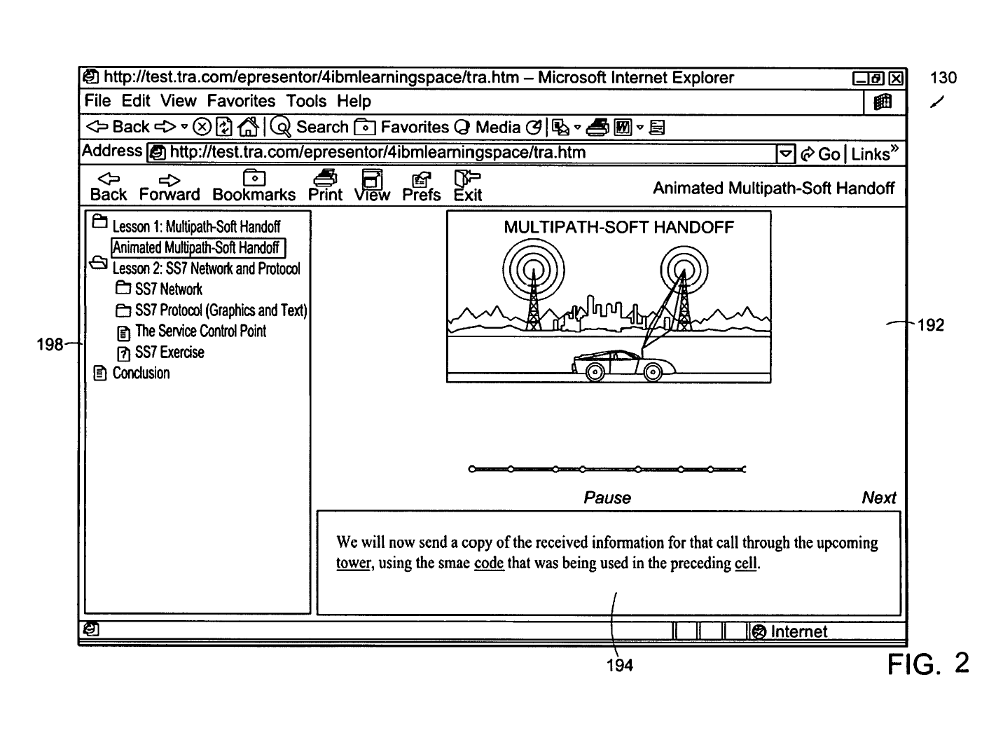

In FIG. 2, an interactive presentation 130 is displayed in a browser user interface. In general, the layout of the interface features four specific areas that display instructional, interactive or navigational content. These four areas are animation-video region 192, closed caption region 194, toolbar 196 and table of contents 198.

The animation-video region 192 can display any type of data object that can be displayed by a web browser. For example, the animation-video region 192 can display Flash objects, web-deliverable video, slide show graphics with or without synchronized sound, or static graphics with or without synchronized sound. In addition to navigational tools, the animation-video region 192 can display interactive exercises and assessments. Examples of types of interactive e-learning exercises and assessments include single question (dichotomous, multiple choice, multiple select), matching (puzzles, building blocks/compare and contract, drag and drop) and ordered list. Interactive exercises and assessments are discussed in U.S. application Ser. No. 10/918,208, filed Aug. 12, 2004, which is incorporated herein by reference in its entirety.

The interactive presentation 130 preferably includes a table of contents 198. The table of contents 198 is a navigation tool that dynamically displays the course structure in a vertical hierarchy providing a high-level and detailed view. The table of contents 198 enables the user to navigate to any given page of the interactive presentation 130. The table of contents 198 uses the course structure file to determine the organization of the interactive presentation 130. The user can navigate the table of contents 198 via mouse interaction or keystroke interaction.

The table of contents 198 is a control structure that is organized by folders, which correspond to chapters 160 (units or sections) and include pages. The chapters 160 and pages are data items of the table of contents 198 that can be stored in node array.

Database Authoring Environment

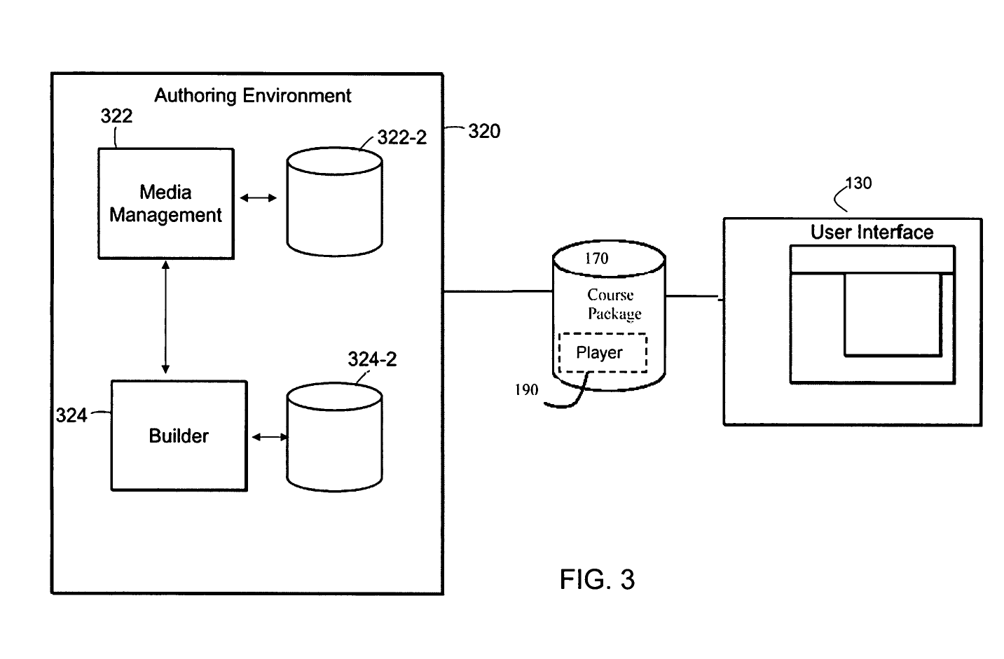

FIG. 3 is a block diagram illustrating database system architecture for creating an interactive presentation 130. A database authoring environment 320 allows an interactive presentation 130 to be developed on a distributed system. The database authoring environment 320 can create an interactive presentation 130 product and, in particular, an e-learning product for an e-learning course.

The database authoring environment 320 includes a media management module 322 and a builder module 324 (X-Builder™) in connection with a database. Both the media management module 322 and builder module 324 include logic for authoring an interactive presentation 130 using databases 322-2, 324-2. The database authoring environment 320 can be used to develop and store a course project, which can be used to create a course package 170 for an interactive presentation 130.

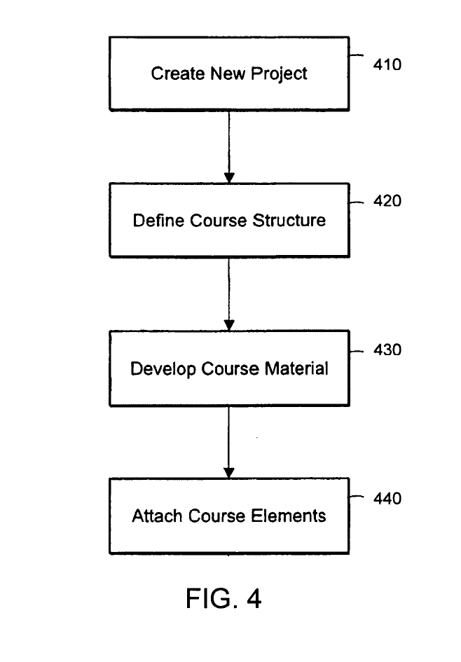

FIG. 4 is a flow diagram showing an example of the process of developing an interactive presentation 130 according to an aspect of FIG. 3. At step 410, the authoring environment 320 creates a new course project for an interactive presentation 130. At step 420, the authoring environment 320 defines a course structure for the interactive presentation 130. The course structure is organized in a hierarchical arrangement of course content. At step 430, the authoring environment 320 provides course material for the course project. The authoring environment 320 stores individual pages with page assets in a master content library. At step 440, the authoring environment 320 packages the course into a software package 170.

Document-Based Authoring Environment

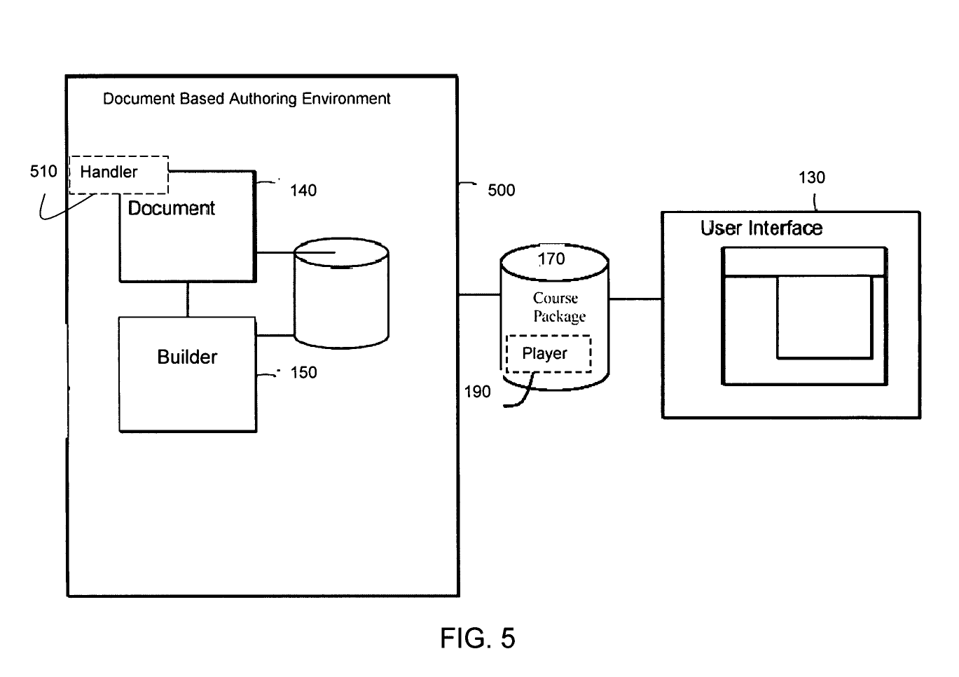

FIG. 5 is a block diagram illustrating the system architecture for creating an interactive presentation in a document-based authoring environment according to an embodiment of the present invention. The system architecture includes a document-based authoring environment 500 and a user interface, which is used to display the interactive presentation 130. The document-based authoring environment 500 is an Automatic Storyboard™ concept that is a combination of a source document 140 and a highly mobile desktop application referred to as the builder 150 (e-Learning Builder™). The document 140 can be in any data processing or web authoring format such as a Microsoft Word, WordPerfect, HTML, Microsoft Outlook, Dreamweaver, FrontPage, ASCII, MIME, BinHex, plain text, and the like.

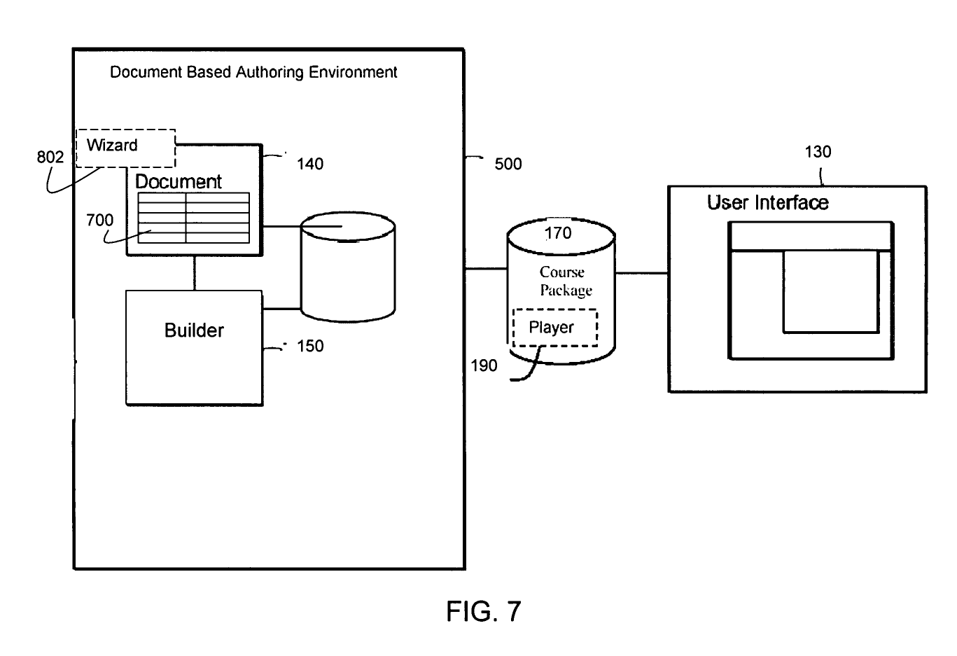

The document 140 is used to specify the format and the content of the interactive presentation 130. For example, if the document 140 is a conventional Microsoft Word document, a user can insert text-based data objects, such as text, closed caption script or HTML code for the presentation. A user can insert into the document 140 path/filenames to various non-text media, such as images, animation, audio or video. The wizard (aka document handler) communicates with the document via an object reference. A document handler 510 may be included to respond to a build request from the document 140. The document handler 510 may be a software component, such as a plug-in that is capable of communicating with or controlling the document 140. As shown in FIG. 7, the document handler can be a wizard 802. To initiate a build process, for example, the user requests may request to “preview” the document from the wizard's user interface. In response to a request to “preview” the document 140 as a presentation, the wizard 802 notifies the builder 150 to initiate the build, and the builder creates the course package 170, which includes the player 190.

Referring back to FIG. 5, functionality for the player 190 can be specified by the developer in the source document 140 using hierarchical headings and pseudo tags (constructs). The constructs can be added manually to the source document 140 by the developer or added automatically using a wizard 802. The document 140 is structured using the constructs, which are specified in document 140 in connection with a Microsoft Word or e-mail application. The constructs define the structure of the document 140 for the builder 150. The builder 150 uses the constructs as instructions to build an equivalent course structure and course table of contents 198 in the course package 170, which can be processed by the player 190 into an interactive presentation 130.

The construct headings in the Microsoft Word document can be converted to HTML header tags (<H1>, <H2>, <H3>, etc.). They can be converted by the builder 150 or by a conventional Microsoft Word application. The builder 150 uses the HTML header tags to instruct the player 190 how to create the interactive presentation. The HTML header tags are converted into the appropriate hierarchical instructions in XML so the player 190 can synchronize the display of the page assets on the user interface.

The HTML header tags can define the title for an interactive exercise or assessment. The HTML header tags can define the XML course structure file, and an XML table of contents. The HTML header tags can define new pages, such as the beginning and ending of pages. In this way, the HTML header tags enable the builder 150 to create XML/HTML instructions for the player 190 to arrange the data for display on the browser user interface. The builder 150 processes constructs that are pseudo tags inside the HTML header tags to determine how to build the XML document. Brackets such as { } enclosing a keyword identifier (e.g. {Storyboard}, {Media},{Exercise}, {Pretest}, {Quiz}) can be used in connection with the header tags to define further instruction for builder 150. Specifically, the builder 150 can process such pseudo tags inside the header tags, and further determine the properties of the page or course. The tags can indicate the type of data on the page and can define the beginning and ending of a page. In comparison, for example, the database authoring environment 320 of FIG. 3 uses a database and a multimedia authoring application to perform this.

The builder 150 processes the tags in the HTML document and places the HTML document into an XML document. The builder 150 builds the XML data based on the HTML header tags. By way of contrast, the database authoring environment 320 of FIG. 3 uses a database file (.dbf) to generate the XML data. The XML data defines a tree structure including elements or attributes that can appear in the XML document.

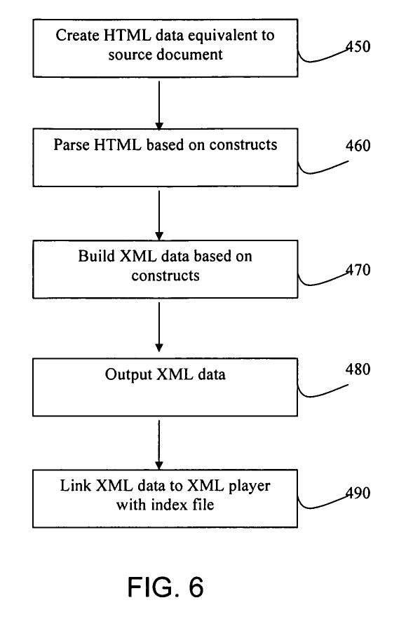

FIG. 6 is a flow diagram describing a document-based authoring process according to an aspect of FIG. 5. At step 450, the document-based authoring system 500 builds an HTML document, which is equivalent to the source document 140. At step 460, the HTML document is parsed based on the constructs. At step 470, an XML document is built based on the constructs. At step 480, the HTML document is output as XML data. At step 490, the XML data is linked to the player 190 with an index file. The index file initiates the player 190 by pointing it at the XML data. This launches the interactive presentation course 130. It should be noted that although the source document 140 is described as being converted to HTML and then to XML, those skilled in the art will appreciate that this is just and example implementation, and the source document 140 may be converted directly to XML or any other format, which is used to create a presentation.

FIG. 7 is a block diagram illustrating an embodiment of the document-based authoring environment 500 according to an embodiment of FIG. 5. In this embodiment, the document 140 includes a table 700. The document 140 can be any type of document, which supports tables. The document 140 and its table are processed by the builder 150 into HTML format, which is processed to a string embedded in an XML document in the course package 170. The text data in the cells of the table 700-1 are processed by the builder 150 into a format, which is processed by the player 190.

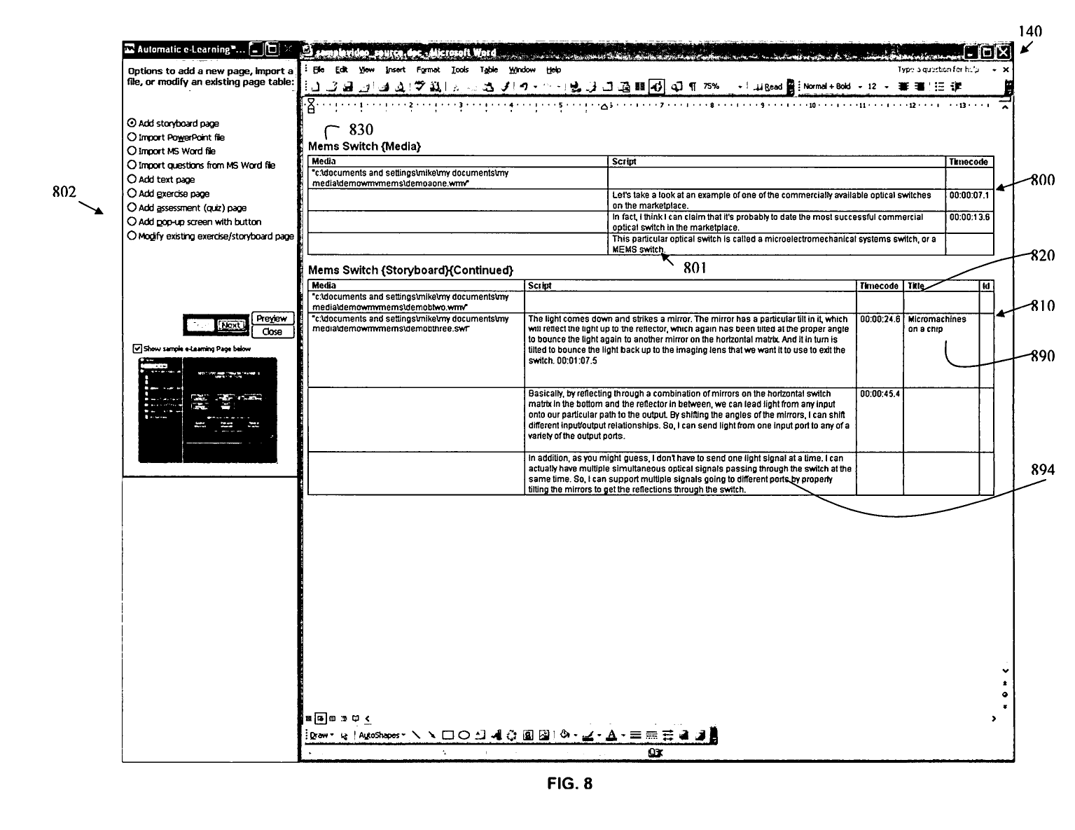

FIG. 8 is a diagram illustrating an interface used in connection with creating an interactive presentation 130 from a document-based authoring environment 500 with a table wizard according to an embodiment of the invention. The source document 140 includes constructs in connection with the tables, which can be used to create a presentation in different ways. If, for example, the construct {Media} appears in the document above the table, the builder recognizes the table as a media table 800. The media table 800 is used by the developer to create a presentation on a page-by-page basis. The media table 800 approach provides an extremely user-friendly environment, which is directly compatible with existing documents.

Instead of using the media table 800 to create the presentation one page at a time, a storyboard table 810 can be used to create a presentation one lesson at a time. While the storyboard table 810 approach is also an extremely user-friendly environment, it also matches how many instructional designers layout a course in a storyboard, as is used in the film industry. The storyboard table 810 also allows a media file, such as audio, video or animation to play across several sequential pages.

For media 800 or storyboard tables 810, the builder 150 constructs associated with the table 700 guide the builder 150 on time-coding the animation video region, table of contents, closed caption region, and progress bar. Specifically, the constructs associated with the table 700 enable the builder 150 to instruct the player 190 as to how to generate the interactive presentation and synchronize the page assets, which are displayed on the user interface.

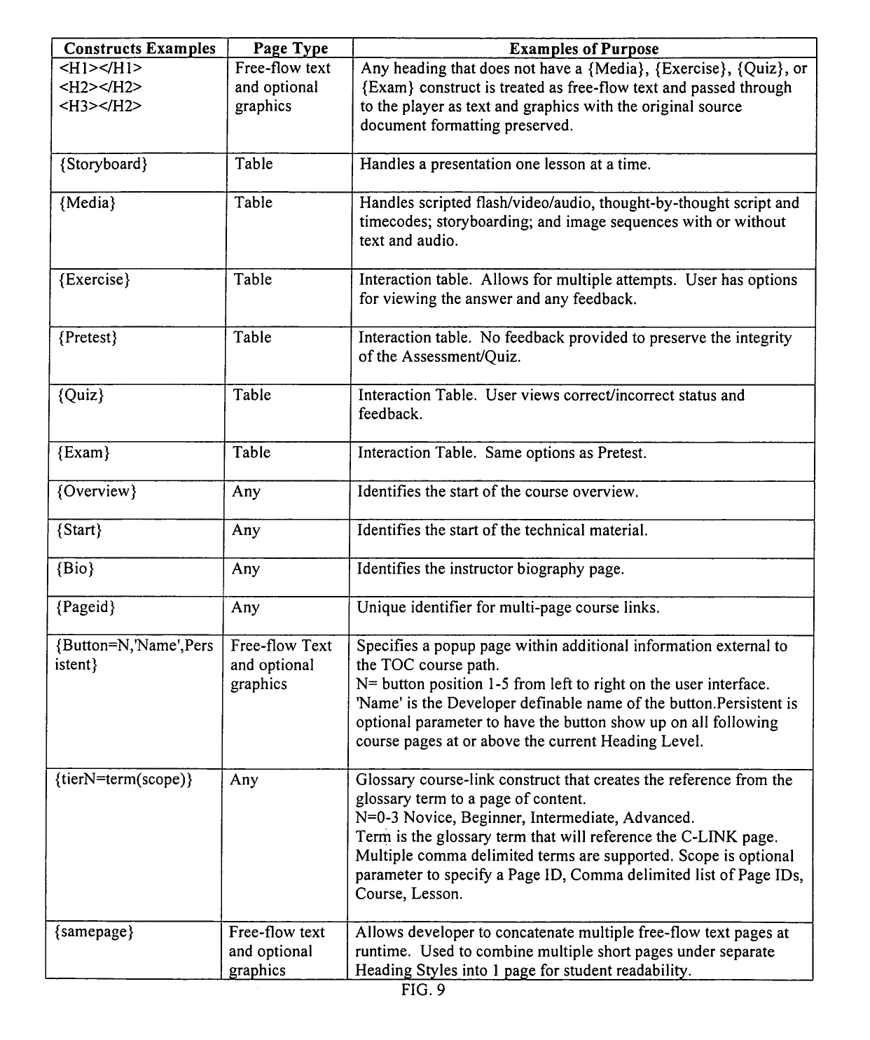

The builder 150 determines the type of table by processing the construct, which appears adjacent to or above the table. In this example, constructs specifying a media table 800 and a storyboard table 810 are shown. Specifically, the builder 150 is responsive to a valid builder construct (e.g., {Storyboard}, {Media},{Exercise}, {Pretest}, {Quiz}). FIG. 9 is a table providing examples of constructs. It should be noted that the constructs provided are for purposes of illustration and that any code that performs the same function as a construct can be used. Referring back to FIG. 8, each lesson in the storyboard table can be identified by its respective lesson title 820, which appears in the title column (to be contrasted with the heading line 830 that identifies the title for page-at-a-time content).

While authoring can be done directly in the source document 140 without any help, the table wizard 802 can provide easy manipulation of the document 140 for adding pages, creating storyboards, importing textual content, converting PowerPoint presentations to Flash files, and synchronizing script, graphics, animations, video and audio using time codes in connection with the document 140.

When the table wizard program 802 is launched in connection with the document 140, an object reference to the document 140 is created and the builder 150 starts the table wizard 802 and calls the Microsoft Word automation server to open the document 140. The builder 150 uses this object reference throughout the table wizard 802 to send commands to Microsoft Word and monitor current activity in the document 140. The table wizard 802 can be created using object linking and embedding (OLE) technology.

Alternatively, a developer may move off of one media table and select a cell in another table (e.g. media table, storyboard table, exercise or assessment table) or move to a text area anywhere else in the document 140. It should be noted that exercise tables are discussed in U.S. application Ser. No. 10/918,208, filed Aug. 12, 2004, which is incorporated herein by reference in its entirety. In moving from a media table to an exercise or assessment table, a refresh of the table wizard 802 will be needed, as well as toggling button states, reloading graphics/media, and possibly change the overall mode of the table wizard 802 based on the table type selected.

All of this communication is managed by a set of algorithms that are running inside of timer-based events on the table wizard 802 form control. Aspects of the table wizard 802, such as the form controls and the timer, can be implemented using Visual FoxPro.

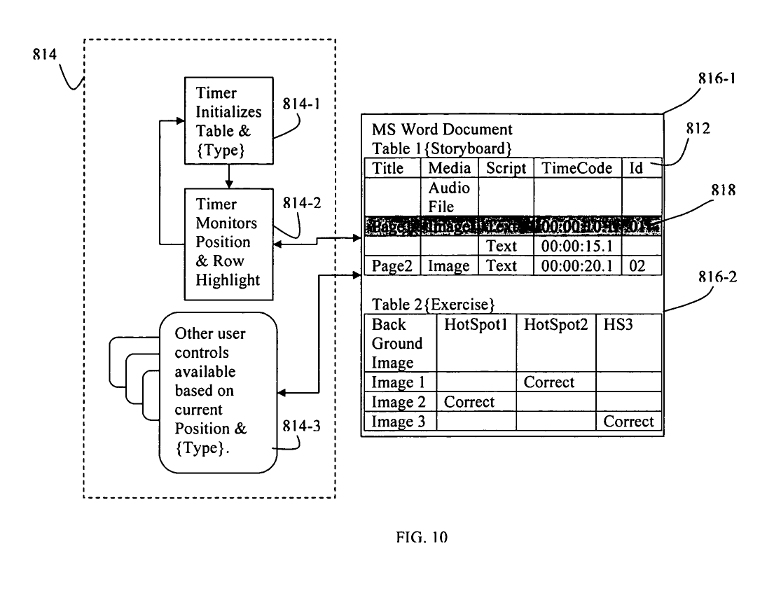

FIG. 10 is a block diagram of the table wizard 802 using a timer process 814 to control and manage the state of a word processing document. An initialization program 814-1 first configures the form based on the current developer position in the document. An Id 812 is assigned to the initial table. This Id 812 is checked every time the table wizard 802 “checks” the document. Once the table wizard 802 is initialized, a timer 814 is turned on. This timer monitors 814-2 and checks the document on a regular interval, for example, every 500 milliseconds. In another embodiment, the timer can be responsive to developer interaction, such as when the developer clicks the mouse or presses a cursor key or another key. The current selection in the document is checked. If the Table Id 812 has changed, the table wizard 802 is re-initialized. If a developer has moved their position in the current table 816-1, 816-2, the visual indicators are updated. If the developer has moved off of a table, the table wizard 802 attempts to re-load, or waits until a user selects a valid table to modify (e.g., Exercise, Pretest, Quiz, Media, or Storyboard). The table wizard 802 provides developer controls at 814-3 based on the current position and construct specified in the table.

The following is an excerpt of code from the timer event 814, which determines the current mouse/cursor position in the document 140. This code verifies that the document is still active, determines which table and row the developer is working on, and decides whether or not to move the row highlight, load a new table, or exit the table wizard 802.

```
This.Enabled=.F.
This.Parent.TmrResize.Enabled=.F.
This.Parent.TmrTime.Enabled=.F.
l_lReturnWithNoTable=.F.
IF TYPE(“This.Parent.r_oWord”)!=“O” OR
ISNULL(This.Parent.r_oWord)
  This.Parent.CmdNext.Click( )
ENDIF
IF TYPE(“This.Parent.r_oWord.Selection.Cells(1).RowIndex”)=“N” ;
  AND !EMPTY(This.Parent.r_cDocId) ;
  AND (TYPE(“This.Parent.r_oWord.Selection.Tables(1)”)=“U” ;
    OR (TYPE(“This.Parent.r_oWord.Selection.Tables(1)”)!=“U” AND
This.Parent.r_oWord.Selection.Tables(1).ID!=This.Parent.r_cDocId) )
  This.Parent.r_lCheckTableintable = .T.
  This.Parent.m_HighlightRow(This.Parent.r_nTableRow,16777215)
  This.Parent.m_Imageopen(“ ”,.F.,.T.) && unload existing file
  This.Parent.r_cFile=“ ”
  IF TYPE(“This.Parent.r_oWord.Selection.Cells(1).RowIndex”)=“N”
    l_nRow=This.Parent.r_oWord.Selection.Cells(1).RowIndex
  ELSE
    l_nRow=−1
  ENDIF
  This.Parent.r_nTableRow=l_nRow
  This.Parent.m_Init( )
  RETURN
ELSE
  ** table is no longer the active selection so,
  ** try to load media table if clicked on Document map or on title
  IF TYPE(“This.Parent.r_oWord.Selection.Cells(1).RowIndex”)!=“N”
    ** get text of title
    IF !EMPTY(This.Parent.r_cFile)
      This.Parent.m_Stopall( )
      This.Parent.m_Imageopen(“ ”,.F.,.T.) && unload existing file
      This.Parent.r_cFile=“ ”
    ENDIF
    This.Parent.m_HighlightRow(This.Parent.r_nTableRow,16777215)
&& change color back
    IF TYPE(“This.Parent.r_oWord. Selection”)=“O”
      IF
EMPTY(This.Parent.r_oWord.Selection.Paragraphs(1).Range.Text)
        TRY
          This.Parent.r_oWord.GOTO(11,3).Select
        CATCH
        FINALLY
        ENDTRY
      ENDIF
  l_cHeaderText=
  This.Parent.r_oWord.Selection.Paragraphs(1).Range.Text
  * l_cHeaderText=This.Parent.r_oWord.Selection.Text && get
title text
      IF ATC(“{media”,l_cHeaderText)>0 ;
        OR ATC(“{studio”,l_cHeaderText)>0 ;
        OR ATC(“{storyboard”,l_cHeaderText)>0 ;
        OR ATC(“{exercise”,l_cHeaderText)>0 ;
        OR ATC(“{quiz”,l_cHeaderText)>0 ;
        OR ATC(“{exam”,l_cHeaderText)>0 ;
        OR ATC(“{hotspots”,l_cHeaderText)>0 ;
        OR ATC(“{test”,l_cHeaderText)>0 ;
        OR ATC(“{pretest”,l_cHeaderText)>0
        This.Parent.r_oWord.Selection.GoTo(2,2) && next table
        IF
TYPE(“This.Parent.r_oWord.Selection.Cells(1).RowIndex”)=“N”
          IF
TYPE(“This .Parent.r_oWord.Selection.Cells(1).RowIndex”)=“N”
  l_nRow=This.Parent.r_oWord.Selection.Cells(1).RowIndex
          ELSE
            l_nRow=−l
          ENDIF
          This.Parent.r_cDocId=“*”
          This.Parent.r_nTableRow=l_nRow
          This.Parent.m_Init( )
          RETURN
        ENDIF
      ELSE
        l_lReturnWithNoTable=.T.
      ENDIF
    ELSE
      ** word is no longer open
      This.Parent.cmdCancel.Click( )
      RETURN
    ENDIF
  ENDIF
ENDIF
```

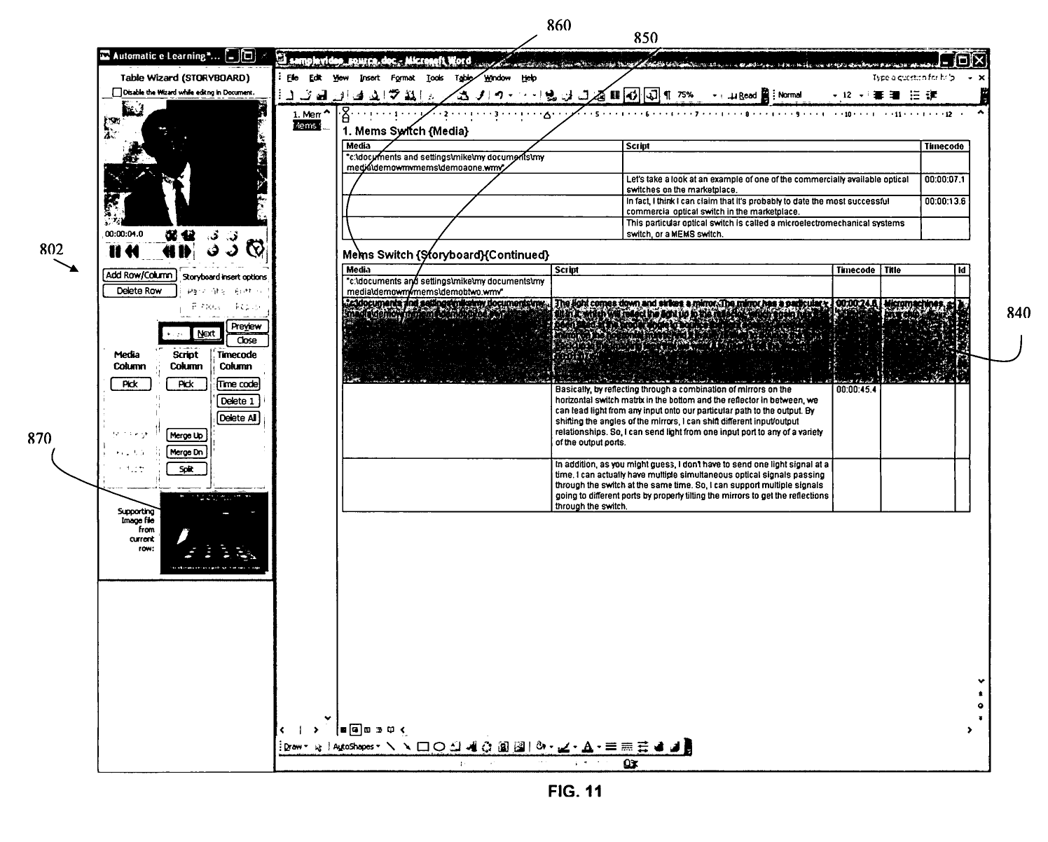

FIG. 11 is a diagram illustrating the selection of a row in a storyboard table according to an embodiment of FIG. 9. As shown in FIG. 11, when a row 840 in the storyboard table 810 is selected, supporting media 850 specified in the media column 860 is processed by the builder 150 in connection with the player 190 and shown on the table wizard 802 interface and displayed 870.

Using the table wizard 802, the developer may:

add or remove rows
select and insert pointers (file name and path) to graphical files
select and insert pointers to audio/visual (movie) and animation files
specify that both a movie and animation file are to play simultaneously (on different parts of the screen)
import and partition (based on sentences, paragraphs or a developer-specified delimiter) closed-caption script
time-code the closed-caption script to the media
in storyboard, embed other page types (e.g., text pages, buttons, exercises, assessments, etc.)
define hotspots for exercise or assessment or graphics
define drop-zones for exercise or assessment

The advanced developer may, with or without the table wizard 802, perform any of the above tasks manually in Microsoft Word and even simultaneously in Microsoft Word with the table wizard 802 program actively monitoring the changes in the document.

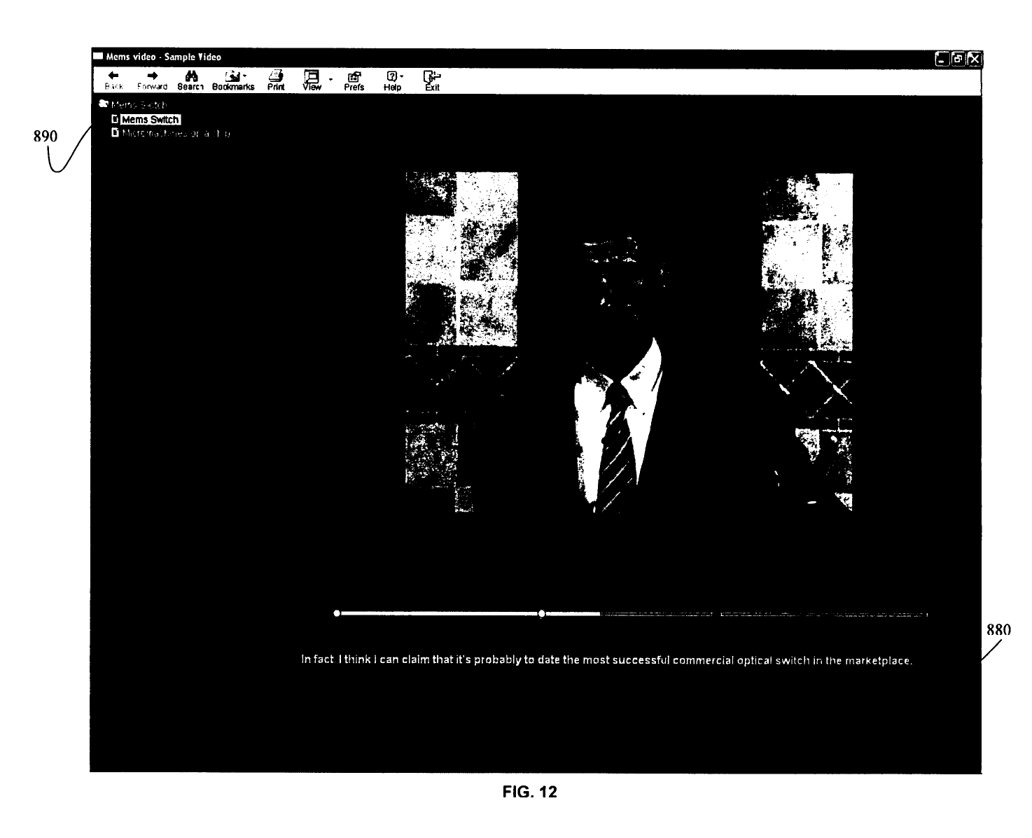

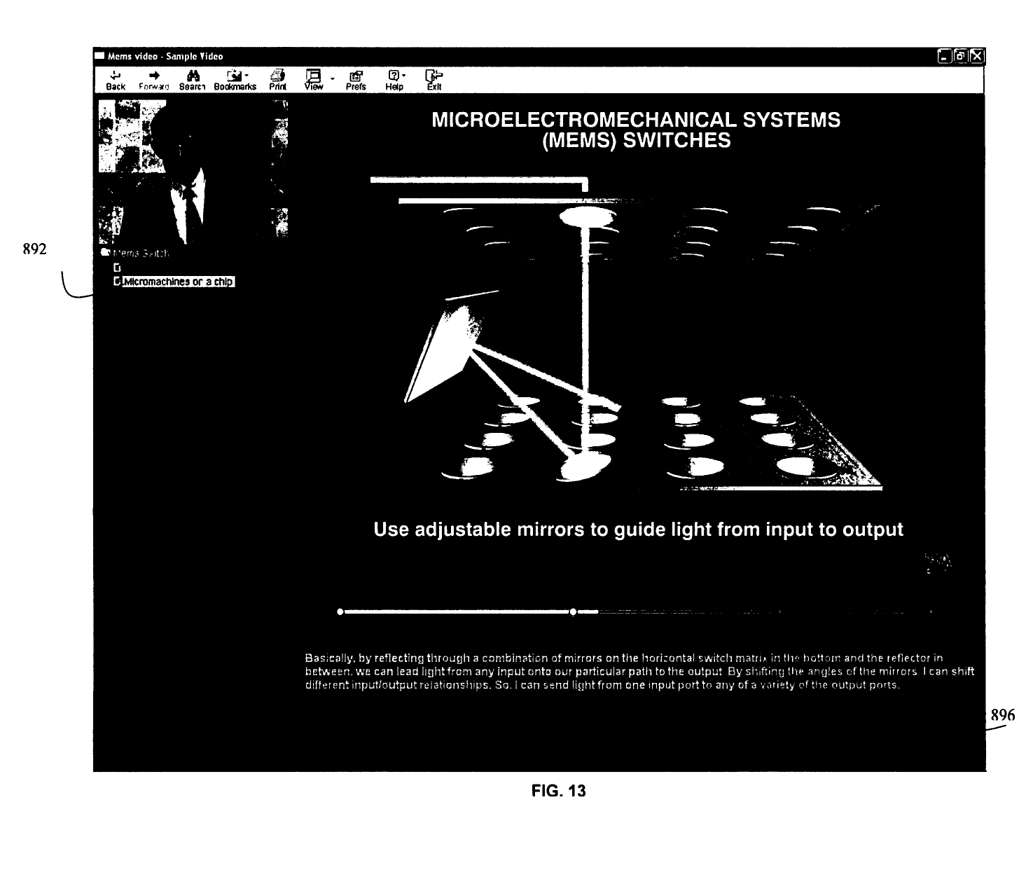

The builder 150 transforms the contents of the source document 140 to the data formats used by the player 190. For example, FIG. 12 is a diagram illustrating a page specified in the media table 800 of FIG. 8. The script 801 specified in media table 800 of FIG. 8 corresponds to the script 880 displayed in the presentation shown in FIG. 12. FIG. 13 is a diagram illustrating the storyboard specified in the storyboard table 810 of FIG. 8. The script 894 specified in the storyboard table 890 of FIG. 8 corresponds to the closed captioned script 880 displayed in the presentation of FIG. 12. The page name 892 referenced in the storyboard table 810 of FIG. 8 corresponds to the page name 892 in the table of contents of FIG. 13.

Referring now to FIGS. 3 and 5, the document 140 based authoring environment 500 provides an alternative authoring environment to database authoring environment 320 of FIG. 3. In particular, the authoring environment 500 of FIGS. 3 and 5 has minimal database requirements, and as a result, it is highly mobile. This allows for offline development. Because the authoring environment 500 is primarily document 140 based, it provides an extremely flexible storyboard-based authoring environment that is highly desirable for instructional designers that work with subject matter experts in disparate locations. For example, data exchange is enabled via email, FTP, File Servers and Microsoft Word applications. Changes made to content in the storyboard are easily reviewed by using standard authoring tools, such as the track changes feature of Microsoft Word. Unlike other industry storyboarding processes, using the builder 150, a course can be built directly from data stored in the source document 140, without accessing a network or accessing a complex database authoring system.

Example Build Process

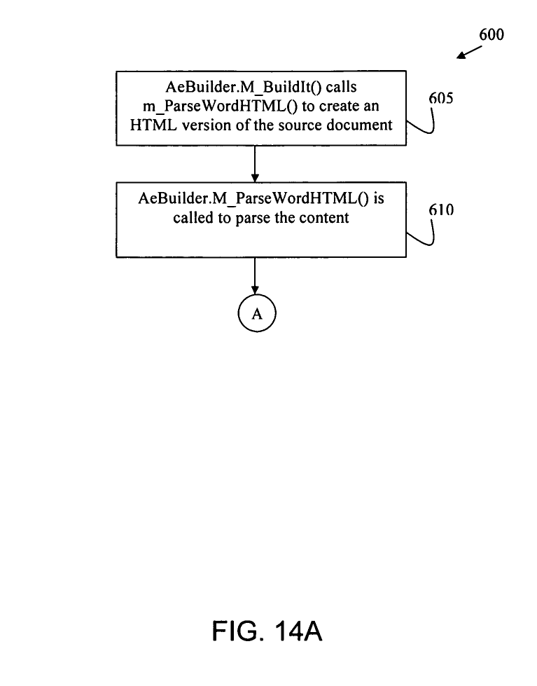

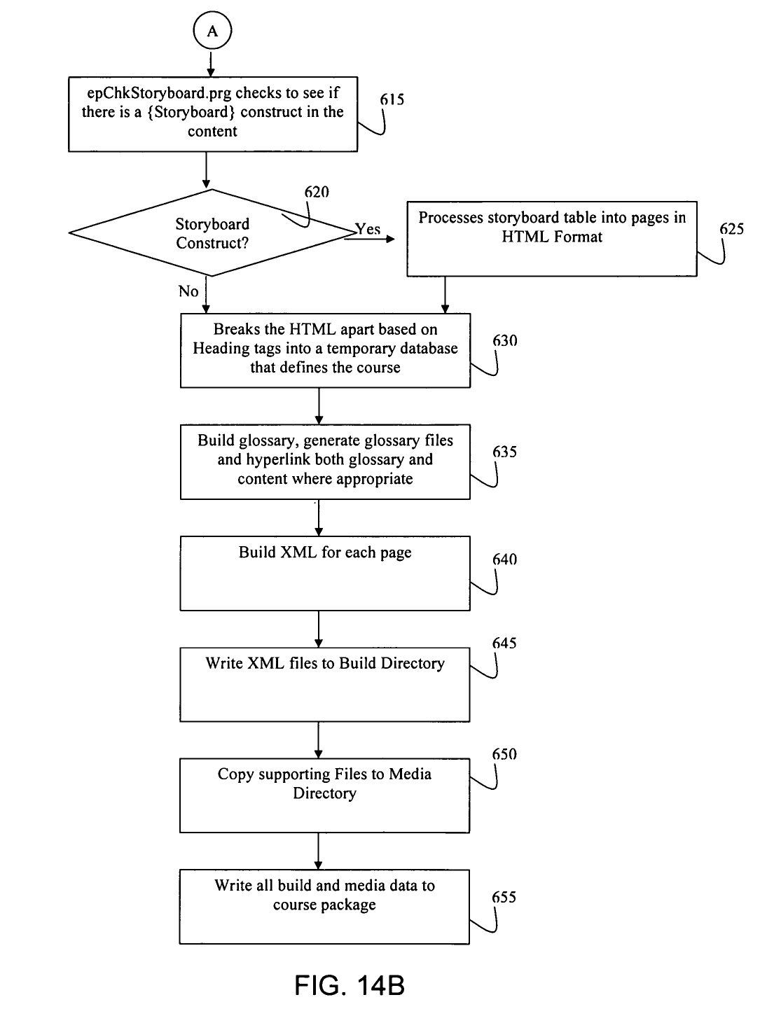

FIGS. 14A-14B are flow diagrams of an example of a software system that handles a build process 600. At step 605, AeBuilder.M_BuildIt( ) calls AeBuilder.m_ParseWordHTML( ), which causes the content of the source document 140 to be saved as HTML. At step 610, AeBuilder.M_BuildIt( ) calls another method, AeBuilder.M_ParseWordHTML( ), to parse the HTML document, which causes various programs to be called to break down the HTML page by page according to the builder constructs (the heading tags), and the data is stored at a temporary location. For example, at step 615, epChkStoryboard.prg is called to look for the {Storyboard} construct. At step 620, if a {Storyboard} construct is found above a table, then at step 625, the storyboard table is broken down into pages in HTML format. If a title is identified in the title column of the storyboard, then the builder knows to begin a new page. If a new title is not provided in the title column, then the builder 150 appends the content in the same page and scans each row for its specified content. At step 630, the heading tags specified in the document are identified, and content that is associated with a specified heading tag is processed differently based on which heading tag/construct is specified.

At step 635, the glossary is built. In particular, the builder 150 generates the first portion of the each glossary entry. The builder 150 formats the glossary entries, creates a reference file in htm format (ref.htm), and the glossary entries are linked with the appropriate content. Preferably, the glossary is developed as described in U.S. patent application Ser. No. 11/029,029, filed Jan. 3, 2005, the entire teachings of which are incorporated herein by reference.

At step 640, the XML is written for the table of contents 198 and for each page specified in the table of contents 198. Specifically, the data that is extracted into HTML and XML tags (constructs) are inserted in the HTML content so that the player 190 can process the content and generate the interactive presentation 130. At step 645, the XML files are written to the build directory. In particular, the XML content is built and written to a temporary location. As each page is processed, the builder 150 writes each page in memory and makes a record of everything that will be written to the build directory. For example, as each page is processed, the builder 150 builds a memory array with all files that are going to be copied in the build directory. Once the builder 150 has completed processing each page, it assigns a file name to the XML and writes it to the build directory. At step 650, all supporting media files are copied to the media directory. At step 655, he build directory and media directory are published to the course package.

Example XML Player

Referring to FIGS. 3 and 5, the database authoring environment 320 and document-based authoring environment 500 both supply a player 190 (Automatic e-Learning Player™) in the course package 170. The player 190 compiles the XML data in the XML document for display in a browser on the user interface. In a particular implementation, a JavaScript program, that is included in the player 190, parses the XML data and displays it in a browser as HTML. The parser also utilizes parsing functions that are native to the browser. It should be noted that the interactive presentation 130 and player 190 functionality is the same, regardless of the authoring platform (e.g. the database authoring environment 320 or document-based authoring environment 500).

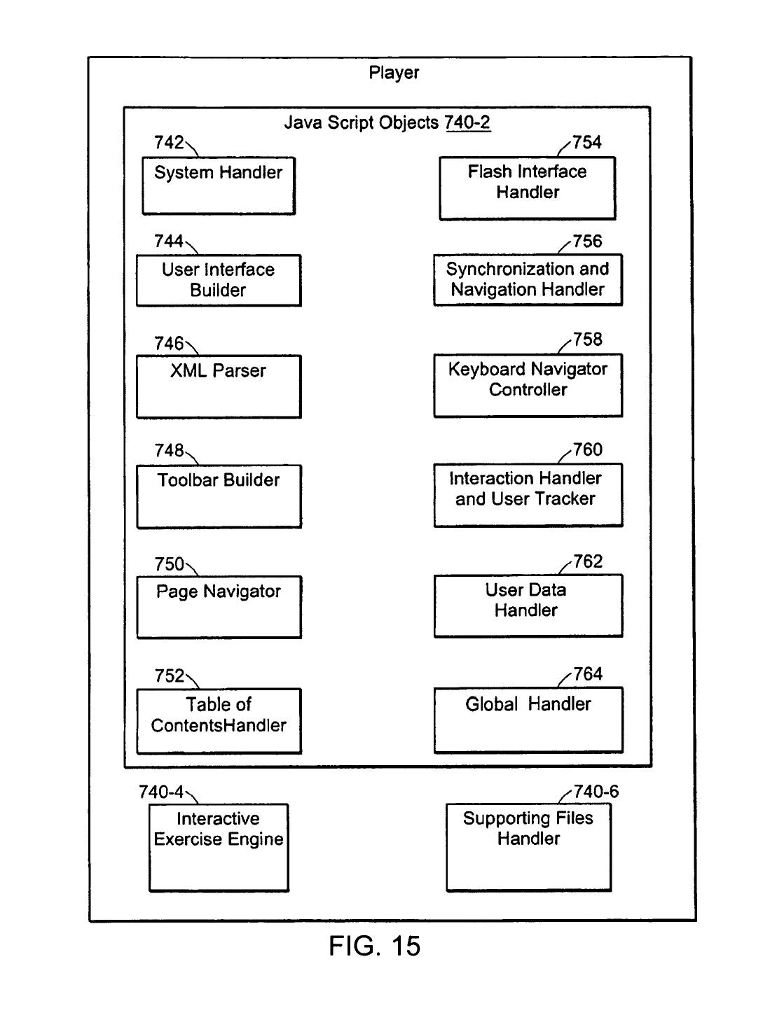

A diagram illustrating an example of a software system that implements a player is shown in FIG. 15. In this embodiment, the player 180 is an XML player 740 and is comprised of three general components: JavaScript programs 740-2, an interactive exercise engine 740-4 (written in a Flash ActionScript file) and handlers for managing other supporting files 740-6, such as GIFs, and HTML files.

The JavaScript programs 740-2 perform a variety of functions for the XML player. A system handler 742 audits the system requirements to make sure that the interactive presentation product can load on the client system. A user interface handler 744 builds the user interface for the interactive presentation product.

An XML parser 746 parses the XML data, such as XML data page assets, and builds an interactive presentation 130 course structure file in memory. The XML parser processes the XML data and renders it into a format that the browser requires. The browser includes functions that are native to the browser that can assist the XML parser 746 in rendering the XML data. The browser then interprets the processed XML data and displays it. The XML parser 746 also handles the XML data, which is processed by the hyper-download system.

A toolbar builder 748 builds the main menu for the interactive presentation 130 product. A page navigator 750 handles page navigation through the interactive presentation 130. A table of contents handler 752 provides table of contents navigation based on the course structure file. A Flash interface handler 754 setups the primary Flash interface. A synchronization and navigation handler 756 loads animations and creates the progress bar, and handles navigation of the closed captioning region of the user interface. A keyboard navigation controller 758 handles navigation events associated with keystroke interactions. An interaction handler and user tracker 760 tracks and scores user's interactions. A user data handler 762 handles user data such as cookie indicators that are stored on the client system or on the server 120, which supports the learning management system. A global handler 764 handles commonly used subroutines. In general, the XML player's 740 interactive exercise engine 740-4 generates the interactive exercises or assessments, and handles communication with the user during the interactions. The XML player 740 can be a web based application.

It will be apparent to those of ordinary skill in the art that methods involved in computerized learning system can be embodied in a computer program product that includes a computer usable medium. For example, such a computer usable medium can include a readable memory device, such as a hard drive device, a CD-ROM, a DVD-ROM, or a computer diskette, having computer readable program code segments stored thereon. The computer readable medium can also include a communications or transmission medium, such as a bus or a communications link, either optical, wired, or wireless, having program code segments carried thereon as digital or analog data signals.

It will further be apparent to those of ordinary skill in the art that, as used herein, “interactive presentation” and “glossary” can be broadly construed to mean any electronic content with text, audio, animation, video or media thereof directly or indirectly connected or connectable in any known or later-developed manner to a device such as a computer. It will also be apparent to those of ordinary skill in the art that, as used herein, “user” can be broadly construed to mean any student, learner or seeker of entertainment, and that, as used herein, “construct” and “headings,” can be broadly construed to mean any code that identifies an element in a document, for the purpose of formatting, indexing, linking, processing, displaying, or generating information in a document. It will be even further apparent to those of ordinary skill in the art that, as used herein, “document” can be broadly construed as any file created with an application. It should be noted that the headings used above are meant as a guide to the reader and should not be considered limiting to the claimed invention.

While this invention has been particularly shown and described with references to particular embodiments, it will be understood by those skilled in the art that various changes in form and details may be made to the embodiments without departing from the scope of the invention encompassed by the appended claims.

1. A computerized method of electronic presentation development and deployment comprising:
accessing an electronic document having presentation data defined by specified constructs, including a storyboard construct;
processing the document to determine presentation data and specified constructs in the document;
responding to a storyboard construct by determining that at least a portion of the presentation data corresponds to storyboard data; and
using the storyboard data to create an electronic presentation.

2. A computerized method as in claim 1 wherein processing the document to determine presentation data and specified constructs further includes processing the presentation data into pages based on the specified constructs.

3. A computerized method as in claim 2 wherein processing the presentation data into pages based on the specified constructs further includes:
parsing the presentation data into HTML pages based on the specified constructs;
storing the HTML pages in a temporary storage location;
generating, from the HTML pages, XML data for each HTML page; and
generating an XML mapping structure defining the sequence of the HTML pages in the presentation.

4. A computerized method as in claim 3 wherein the XML mapping structure corresponds to a course structure file defining chapters in the presentation, where the chapters have respective pages.

5. A computerized method as in claim 4 wherein the XML mapping structure further controls at least one of: textual content, synchronization information, pointers to media files, hotspots, and drop-zones associated with each page in the presentation.

6. A computerized method as in claim 1 wherein responding to a storyboard construct by determining that at least a portion of the presentation data corresponds to storyboard data further includes:
identifying an electronic table adjacent to the storyboard construct in the document; and
determining that the table corresponds to a storyboard table.

7. A computerized method as in claim 6 wherein the storyboard data is specified in cells of the storyboard table.

8. A computerized method as in claim 7 wherein the storyboard data defines electronic content associated with the presentation including at best one of textual content, synchronization information, pointers to media files, interactive exercises, buttons, images with hotspots, and drop-zones.

9. A computerized method as in claim 8 wherein the electronic content associated with each page in the presentation is controlled using the storyboard table.

10. A computerized method as in claim 10 wherein the storyboard table enables media files to play across several sequential pages in the presentation.

11. A computerized method as in claim 1 wherein processing the document to determine presentation data and specified constructs further include comparing the specified constructs with builder constructs.

12. A computerized method as in claim 11 wherein the builder constructs include at least one of a storyboard construct, a media construct, an exercise construct, a pretest construct, and a quiz construct.

13. A computerized method as in claim 1 wherein the document is a word processing document or e-mail.

14. A computerized method as in claim 1 further includes specifying media content for the presentation without having network connectivity and without having access to a database.

15. A computerized method as in claim 14 wherein specifying media content further includes mapping the electronic content to pages in the presentation without having network connectivity and without having access to a database.

16. A presentation development and deployment system comprising:
a document handler responsive to one or more builder constructs specified in an electronic document, where one of the builder constructs is a storyboard construct; and
a builder, in communication with the document handler, the builder determining a structure for an electronic presentation based at least in part on the storyboard construct specified in the document.

17. A presentation authoring and production system according to claim 16 wherein the builder determining a structure for an electronic presentation further includes a build process that processes the document to identify presentation data and associated builder constructs specified in the document to generate an equivalent structure in computer readable instructions associated with the electronic presentation.

18. A presentation authoring and production system according to claim 16 wherein the build process generates an equivalent structure in computer readable instructions associated with the electronic presentation by:
parsing the presentation data and builder constructs into HTML pages based on the builder constructs;
storing the HTML pages in a temporary location;
generating, from the HTML pages, XML data for each HTML page; and
generating an XML mapping structure defining the sequence of the HTML pages in the presentation.

19. A presentation authoring and production system according to claim 17 wherein the XML mapping structure, HTML pages and XML data for each HTML page are processed by an XML player.

20. A computer program product comprising:
a computer readable medium having computer readable instructions to create an electronic presentation using machine readable code for:
responding to one or more builder constructs specified in an electronic document,; and
determining a structure for an electronic presentation based at least in part on the construct specified in the document.

21. A software system comprising:
means for processing the document to determine presentation data and associated constructs specified in the document, where a storyboard construct is one of the specified constructs;
means for responding to a storyboard construct by determining that at least a portion of the presentation data corresponds to storyboard data; and
means for using the storyboard data to create an electronic presentation.
